(19) United States
(12) Patent Application Publication
(10) Pub. No.: US 2014/0036490 A1
(43) Pub. Date: Feb. 6, 2014

(54) LIGHT ASSEMBLY

(71) Applicants: Joanne Baron, North Ridgeville, OH (US); Jim Norris, Brecksville, OH (US)

(72) Inventors: Joanne Baron, North Ridgeville, OH (US); Jim Norris, Brecksville, OH (US)

(21) Appl. No.: 13/925,519

(22) Filed: Jun. 24, 2013

Related U.S. Application Data
(60) Provisional application No. 61/663,762, filed on Jun. 25, 2012.

(51) Int. Cl. F21L 4/04

(52) U.S. Cl. CPC F21L 4/04
USPC 362/190

(57) ABSTRACT

A light assembly (20) comprising a base (30) adapted for attachment to the substrate (10) and a cartridge (40) slidably attached to the base (30). A cam (50) is movably connected to the cartridge (40) for selective movement between a light-off position and a light-on position. An illuminator (60) is mounted on the cam (50) for movement therewith and electrical connection arrangement (80) automatically turns the illuminator (60) on when the cam (50) is moved to its light-on position.

### RELATED APPLICATION

This application claims priority under 35 USC §119(e) to US Provisional Patent Application No. 61/663,762 filed on Jun. 25, 2012. The entire disclosure of this provisional patent application is hereby incorporated by reference.

### BACKGROUND

Circumstances often arise when it is necessary or at least helpful to illuminate a certain area to accomplish a task. Overhead lighting may not be available for environmental, emergency, secrecy, or unplanned power outage reasons. Even if overhead light is available, it may conflict with sleep-encouraging and/or mood-setting objectives. In either or any event, carrying a light may not be possible, practical, or preferred, if the task requires one or more hands to accomplish. Additionally or alternatively, overhead lighting may not adequately focus light to a particular region and/or may not be energy efficient if only a small area needs to be illuminated.

### SUMMARY

A light assembly is provided which is adapted for attachable to a substrate, such as the brim of a conventional hat, cap, or visor. The light assembly can be compactly constructed, can be economically manufactured, and can be easily operated, without compromising efficiency and effectiveness.

### DRAWINGS

FIGS. 1A-10 each show a substrate 10 with a light assembly 20 attached thereto.

FIG. 2A schematically shows the light assembly 20 in a light-on condition, FIG. 2B schematically shows the light assembly 20 in a light-off condition, and FIG. C shows a possible form for the light assembly 20.

FIGS. 3A-3E, FIGS. 4A-4E, FIGS. 5A-5E, FIGS. 6A-6E, FIGS. 7A-7E, show upper, lower, front, rear, and lateral views of a base 30, a cartridge 40, a cam 50, an illuminator 60, and a power source 70.

FIGS. 8A-8E show upper, lower, front, rear, and lateral views of an electrical connection 80 when the cam is in a light-off position, and FIG. 8F is a lateral view of the electrical connection when the cam is in a light-on position.

### DESCRIPTION

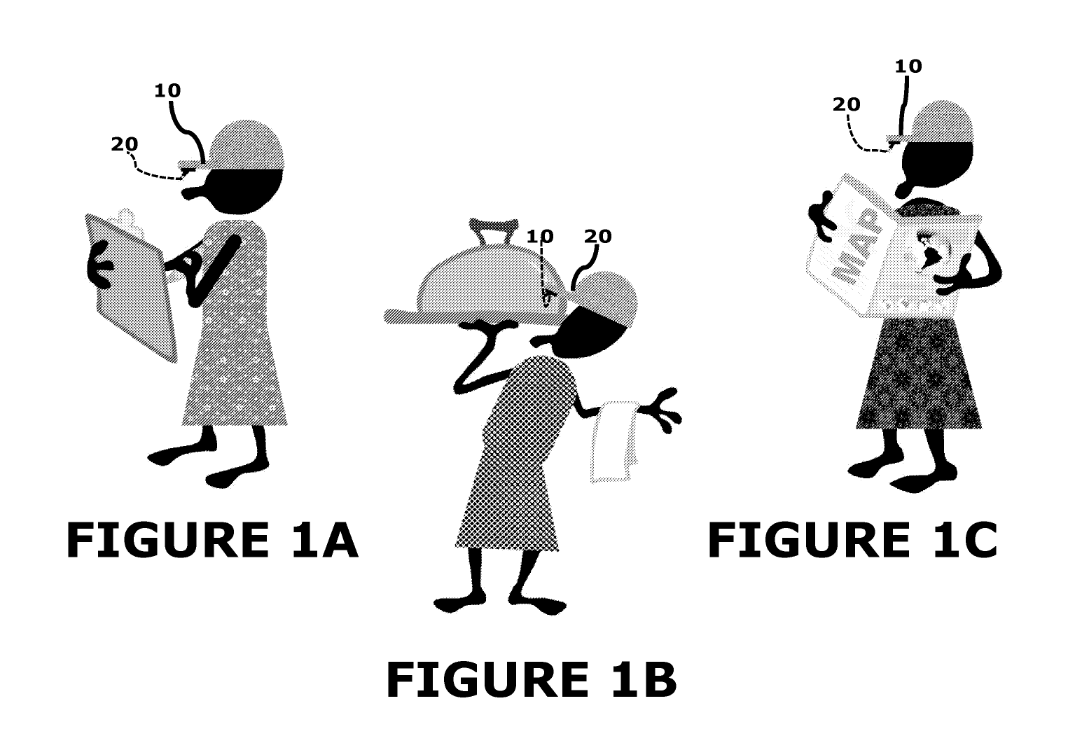

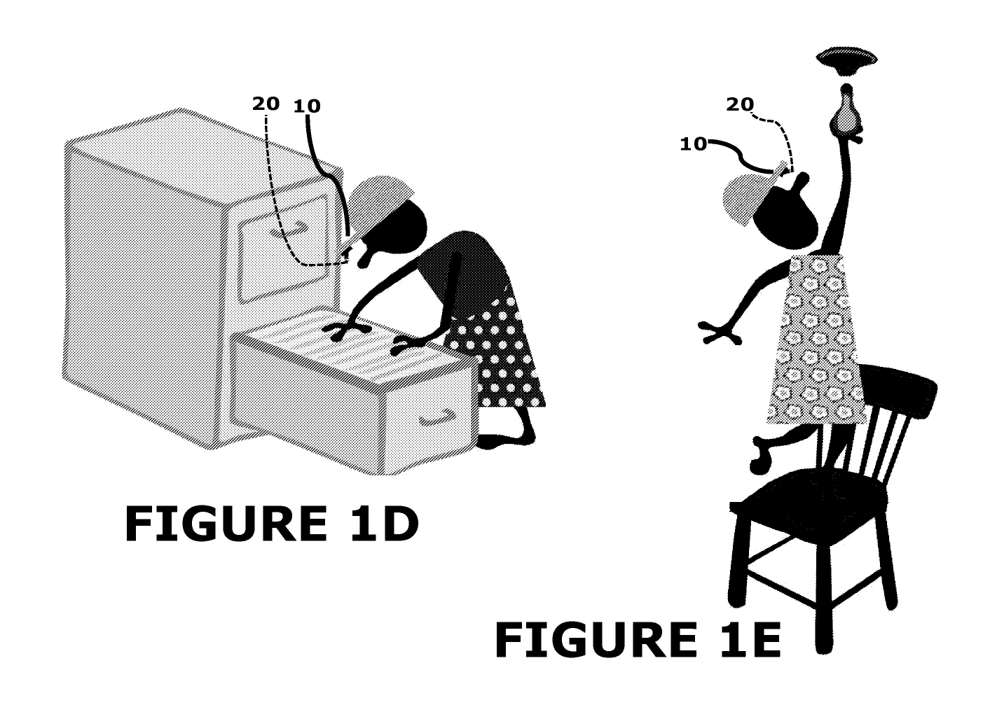

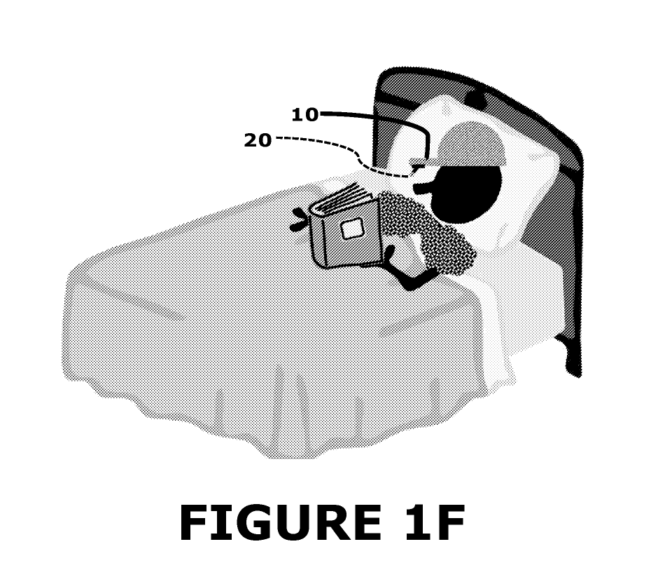

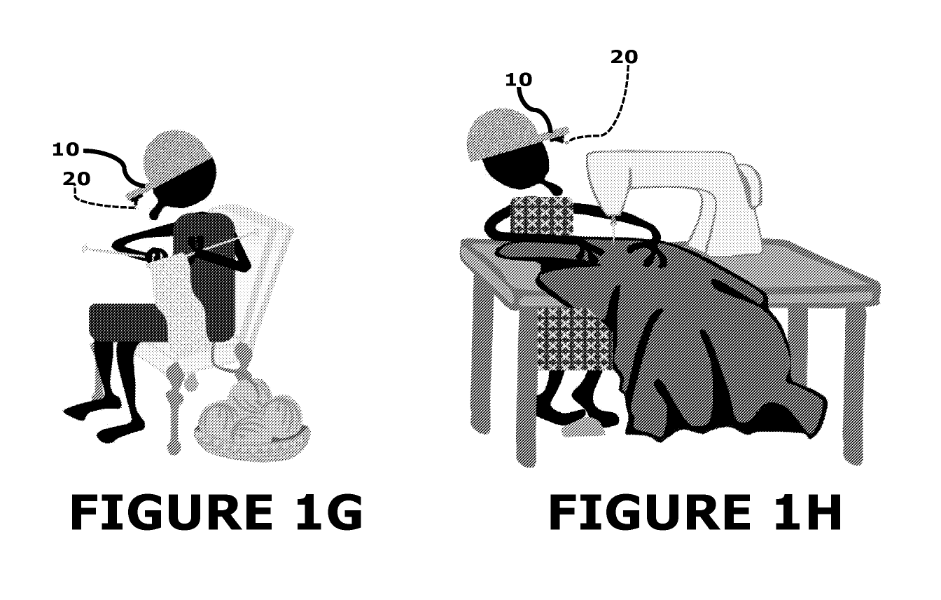

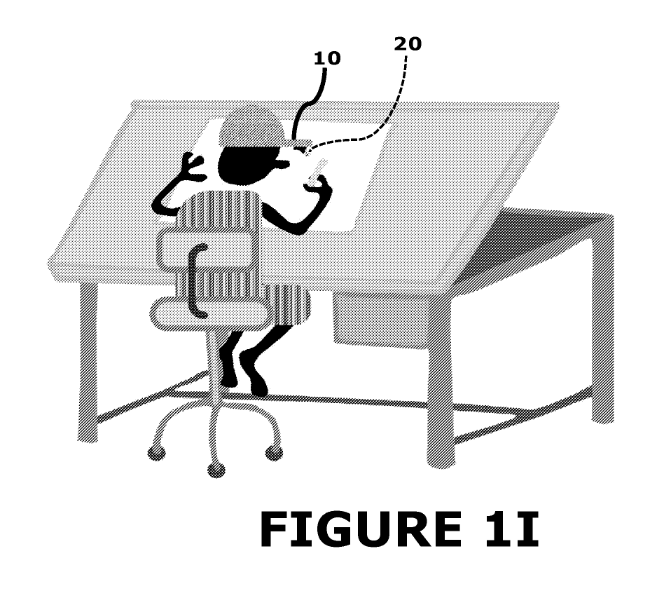

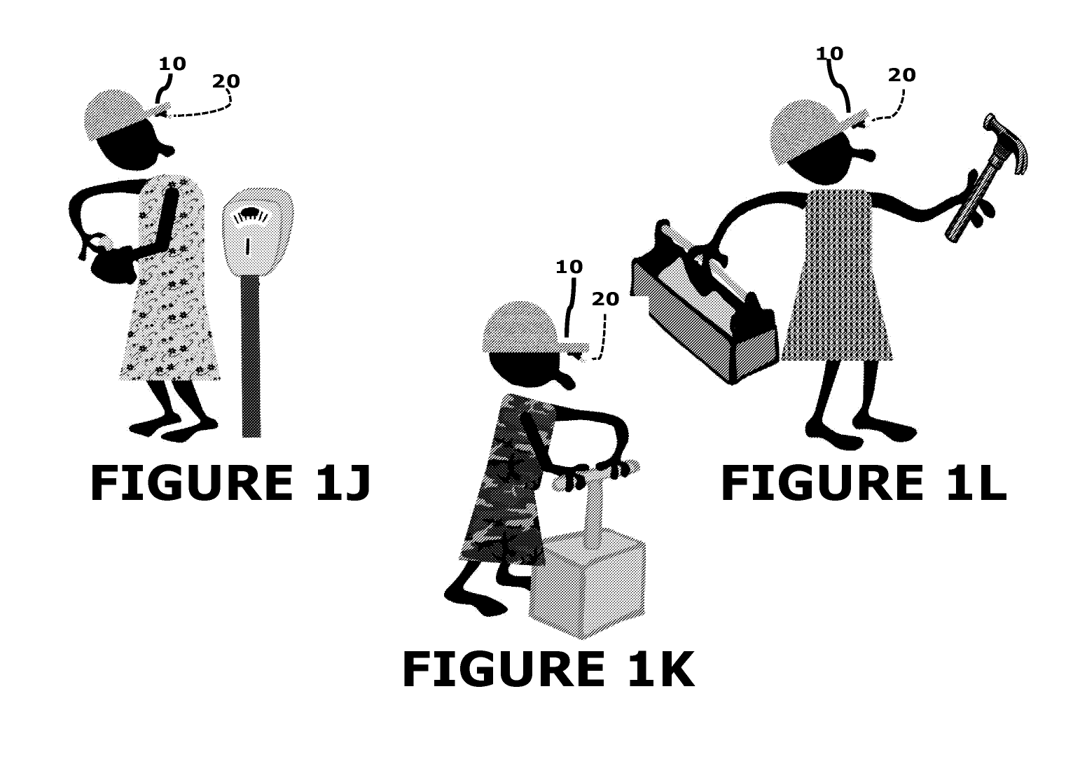

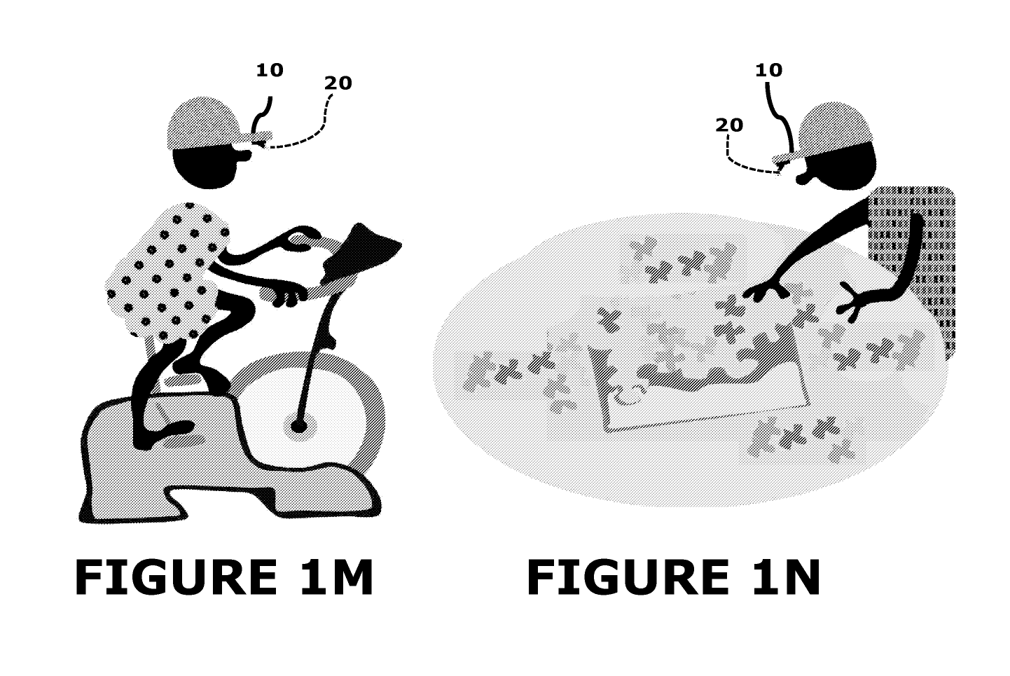

Referring now to the drawings, and initially to FIGS. 1A-10, a substrate 10 is shown with a light assembly 10 attached thereto. In the illustrated situations, overhead lighting may not be available, it may conflict with sleep-encouraging and/or mood-setting objectives, and it may not adequately focus light to a particular region and/or may not be energy efficient.

The illustrated substrates 10 are each part of hat, cap, or visor, and they are shown attached to lower surface of the brim. Attachment to the upper surface of the brim, other areas of the cap, or even other substrates is possible and predicted. For example, the light assembly 10 could instead be affixed to a clipboard, a serving tray, a map, a file cabinet, a light socket, a bed board, a chair back, a sewing machine, a drafting table, a parking meter, a military device, a tool or tool box, a table, exercise equipment, a car hood, etc.

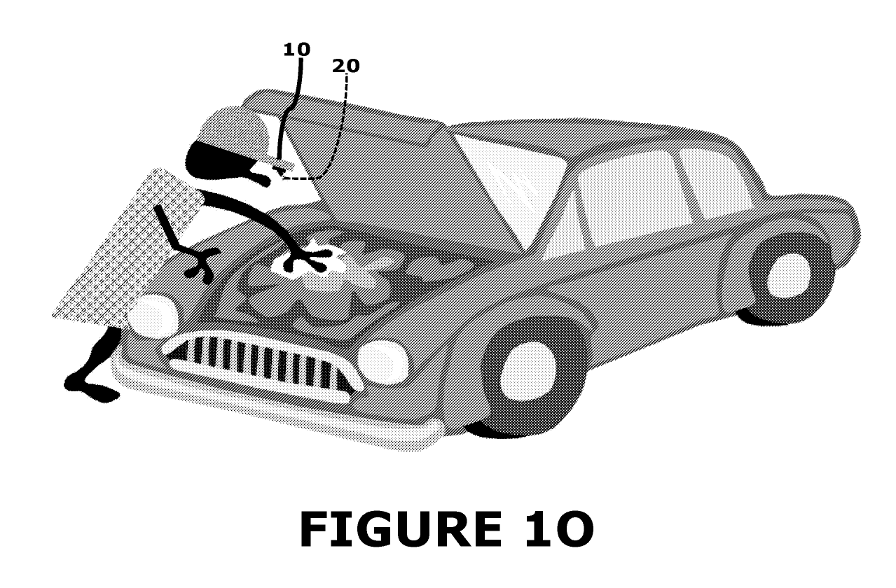

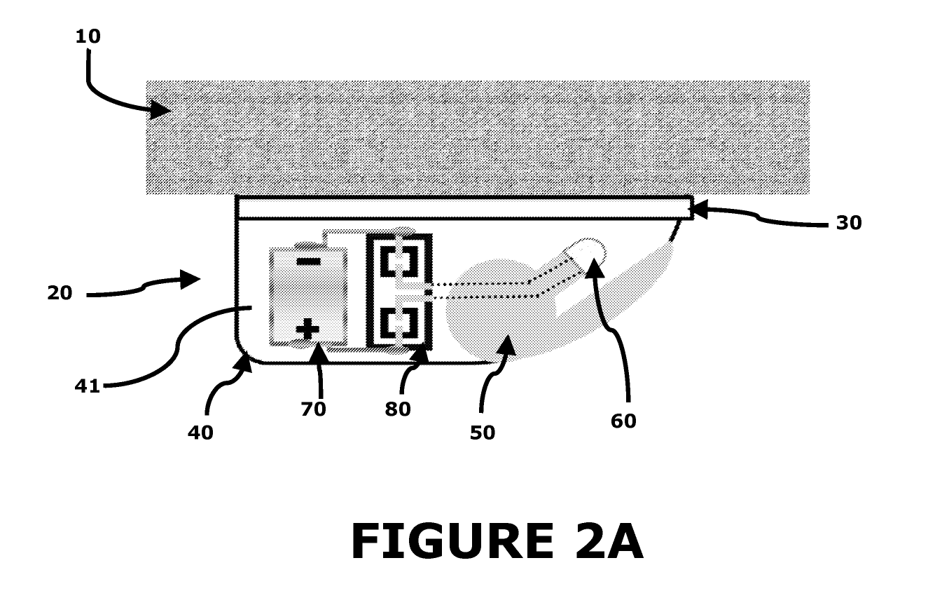

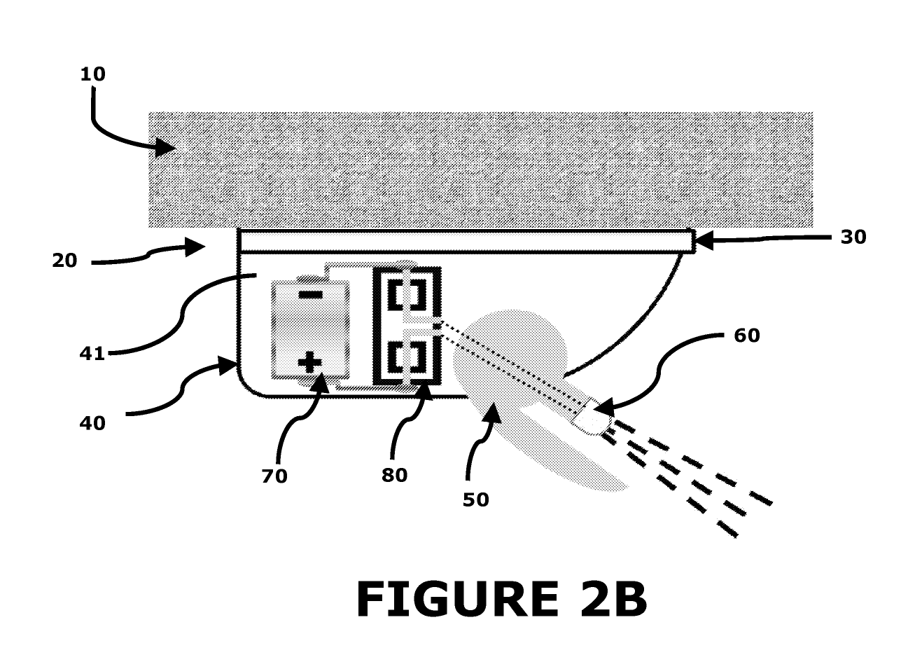

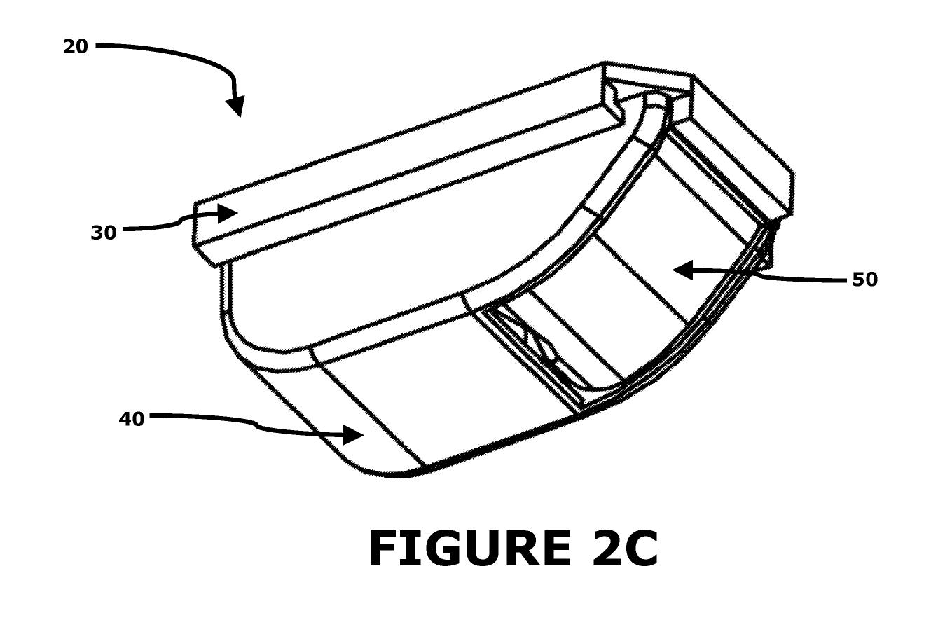

Referring to FIG. 2A and FIG. 2B, the light assembly 20 is shown in more detail. The light assembly 20 comprises base 30 adapted for attachment to the substrate 10 and a cartridge 40 attached to the base 30 and defining a compartment 41. A cam 50 is movably attached to the cartridge 40 for selective movement between a light-off position and a light-on position.

The base 30 can be removably attached to the substrate 10 so that the substrate 10 can be used without the light assembly 20 and/or so that the entire light assembly 20 can be replaced or repaired. The cartridge 40 can be removably attached to the base 30 so that the cartridge 40 per se can replaced and/or so that access can be gained to the compartment 41. In any event, the orientation of the base 30 will determine the orientation of the cartridge 40 and thus the orientation of the hub 50.

An illuminator 60 is mounted on the cam 50 for movement therewith between the light-off position the light-on position. When the cam 50 is in the light-off position, the illuminator 60 is situated within the cartridge 41. When the cam 50 is in the light-on position, the illuminator 60 is situated to shine in forward of the cartridge 40 in a slanted (e.g., upward or downward) direction.

Accordingly, the light assembly 20 provides directional illumination and is not limited to shining in on straight forward (i.e., nonslanted) direction. And other directional vectors of illumination can be customized by placement of the base 30.

A power source 70 is situated within the compartment 41. An electrical connection arrangement 80 supplies the illuminator 60 with electrical power from the source 70 when the cam 50 is in the light-on position but not when it is in the light-off position. This allows the illuminator 60 to be automatically turned on by selectively moving the cam 50 to the light-on position and the illuminator 60 to be automatically turned off by selectively moving the cam 50 to the light-off position.

Accordingly, the light assembly 10 can be easily operated by simply moving the cam 50 between the light-off position and the light-on position. There is no separate on-off switch or other complicated operating paraphernalia. And all wiring can be located internally within the compartment 41 of the cartridge 40.

Referring to FIG. 2C, a working embodiment of the lighting assembly 20 is shown. This lighting assembly 20 can compactly constructed so as to occupy only a small space on and/or to add only minimal weight to the substrate 10. Specifically, for example, the overall dimensions of the lighting assembly 20 can be less than 4 cm long (i.e., the dimension in front-rear direction), less than 3 cm wide, and less than 2 cm high. The base 30 can be less than 4 cm long and less thn 3 cm wide. The cartridge 40 can be slightly shorter and/or slightly narrower than the base 30 and it can be less than 2 cm high. The hub 50 is almost as wide and/or almost as high as the cartridge 40. Specifically, for example, the hub 50 can be at least 50% as wide as the cartridge 40, at least 60% as wide as the cartridge 40, at least 70% as wide as the cartridge 40, and/or at least 80% as wide as the cartridge 40.

This light assembly 20 can also be economically manufactured. For example, the base 30, the cartridge 40, and the hub 50 can each be molded in one piece. The cartridge 40 is preferably slidably (and removably) connected to the base 30. The hub 50 can be preferably pressfit into the cartridge 30.

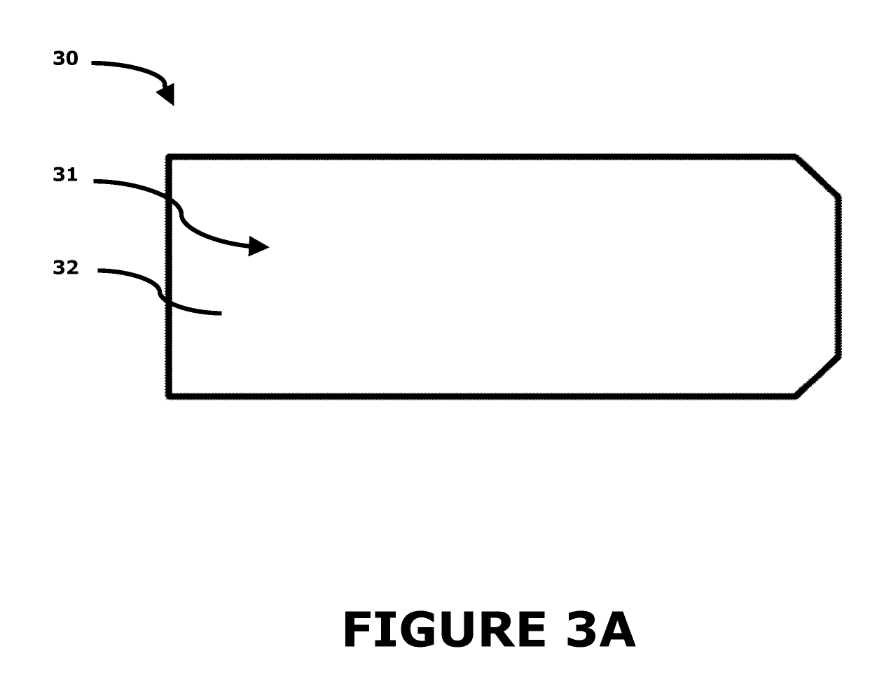

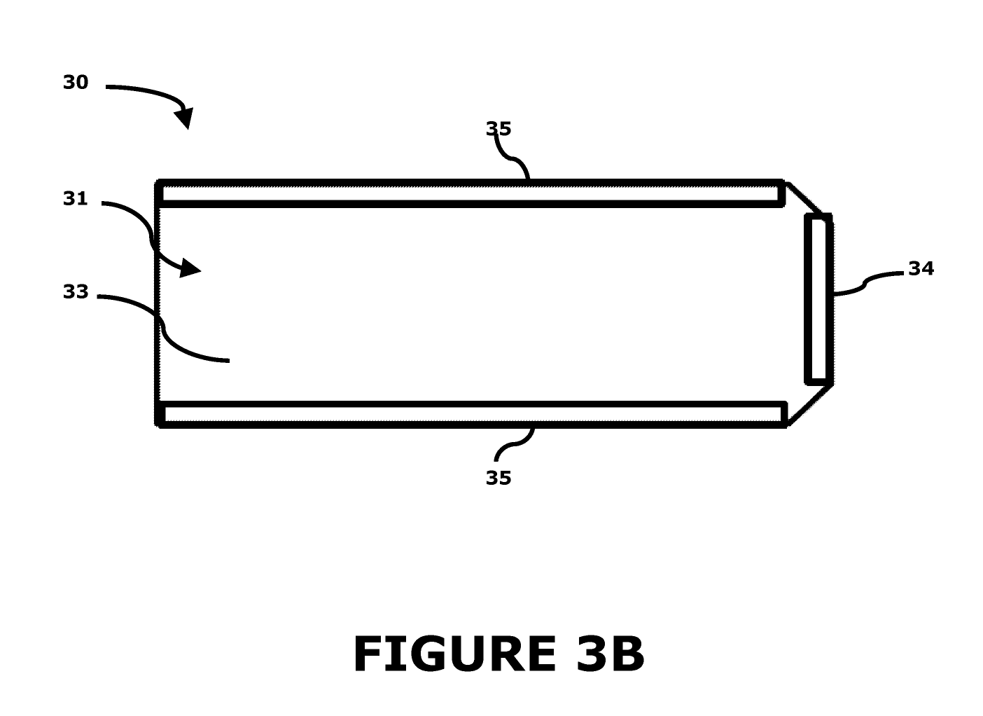

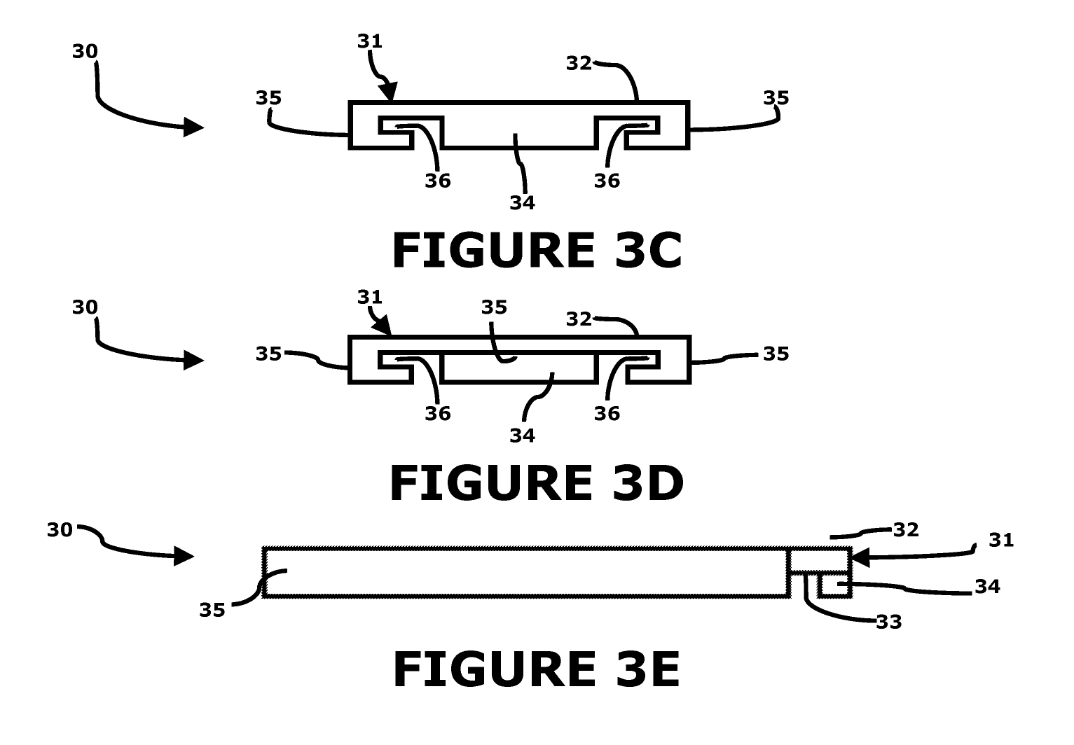

Referring to FIGS. 3A-3E, the base 30 comprises a platform 31 having an upper substrate-attaching surface 32 and a lower cartridge-adjacent surface 33. A bumper 34 projects downward from the front edge the platform 31. A gutter 35 projects downward from each lateral edge of the platform 31 and each gutter 35 defines a rail-receiving groove 36.

The platform surface 32 is attached to the substrate 10 by, for example, hooks-and loops (e.g., Velcro™), stitching, adhesive, or other suitable means. A base 30 which is formed in one piece with the substrate 10 is also feasible and foreseeable.

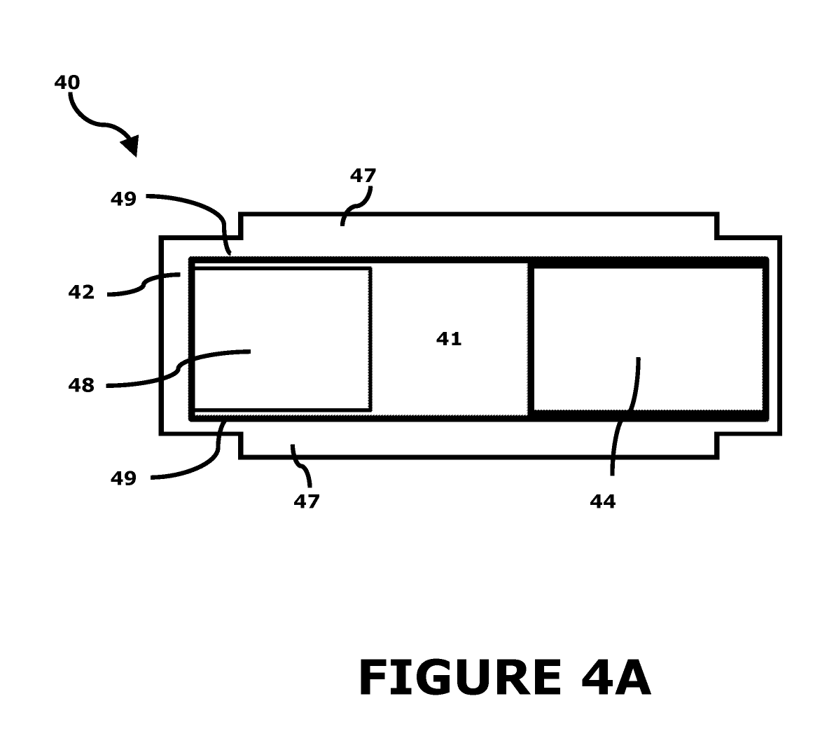

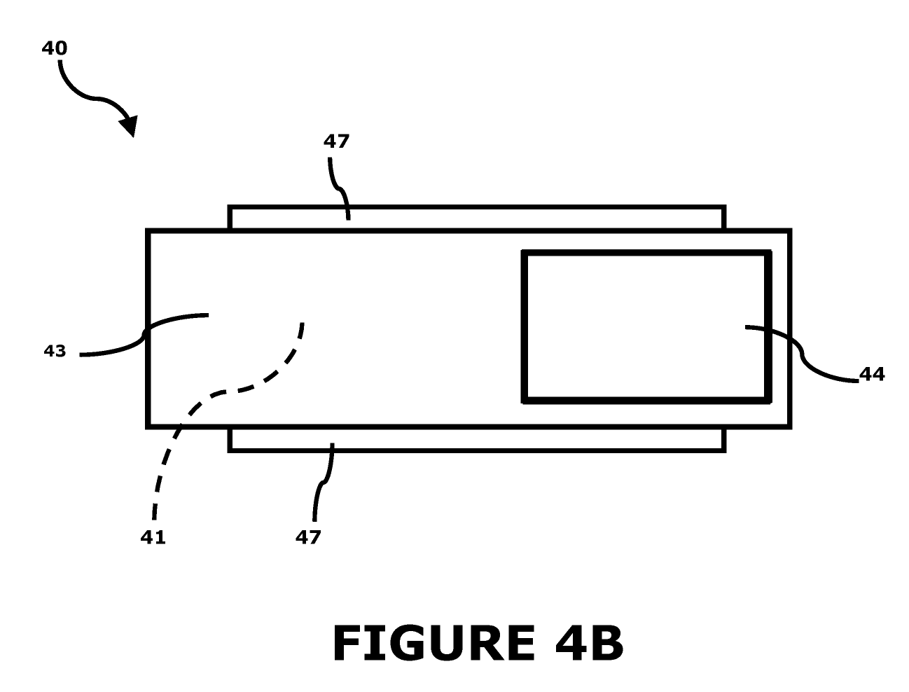

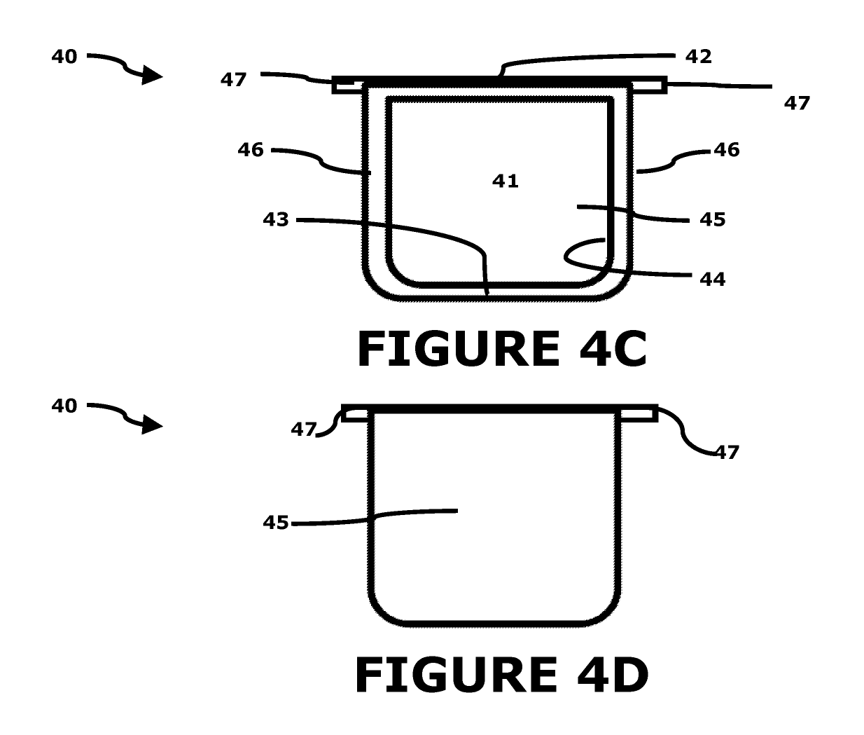

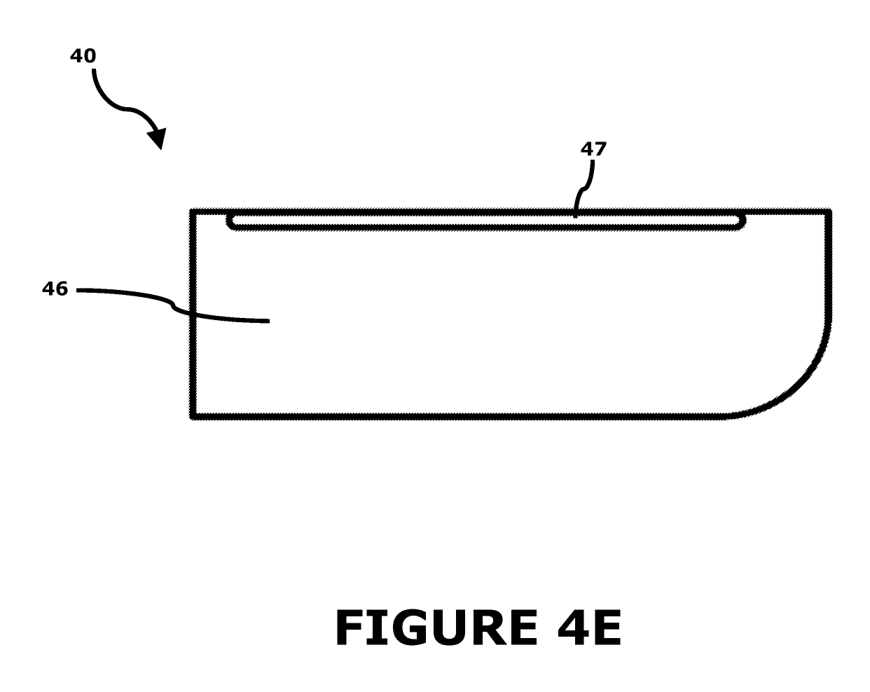

Referring to FIGS. 4A-4E, the cartridge 40 comprises an upper base-adjacent wall 42, a lower wall 43, a front wall 44, a rear wall 45, and side walls 46 which define the compartment 41. The upper wall 42 can be in the form of a rim surrounding a top insertion opening and the front wall 44 can be in the form of a hub-accommodating window. Rails 47 project outward from the lateral edges of the upper wall 42. The cartridge 40 can further comprise interior walls forming a battery holder 48 and narrow slots 49 on either side thereof.

The cartridge 40 can connects to the base 30 by sliding thereinto in the forward direction. The rails 47 are received by the grooves 36 in the platform gutters 35 and the bumper 34 acts as front stop for the leading edge of the cartridge 40.

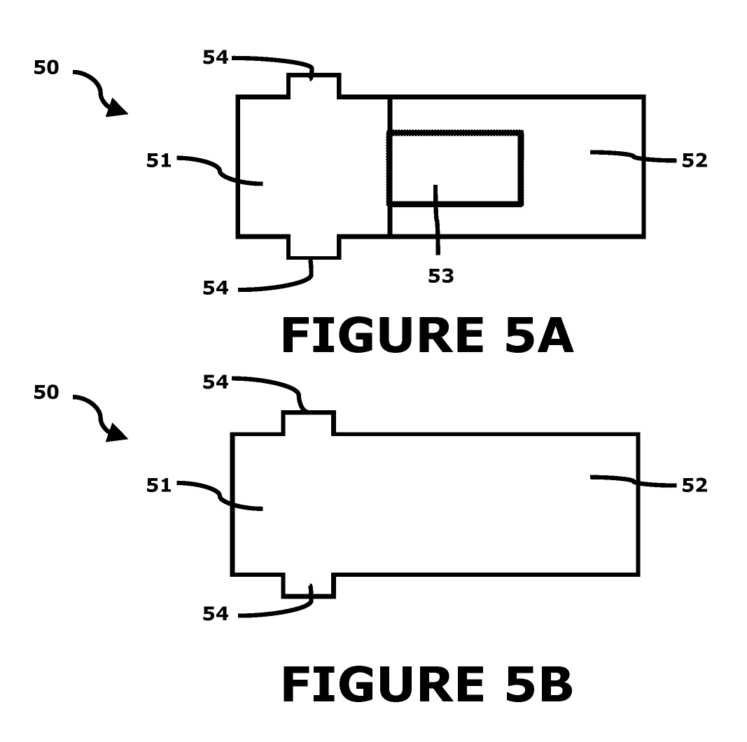

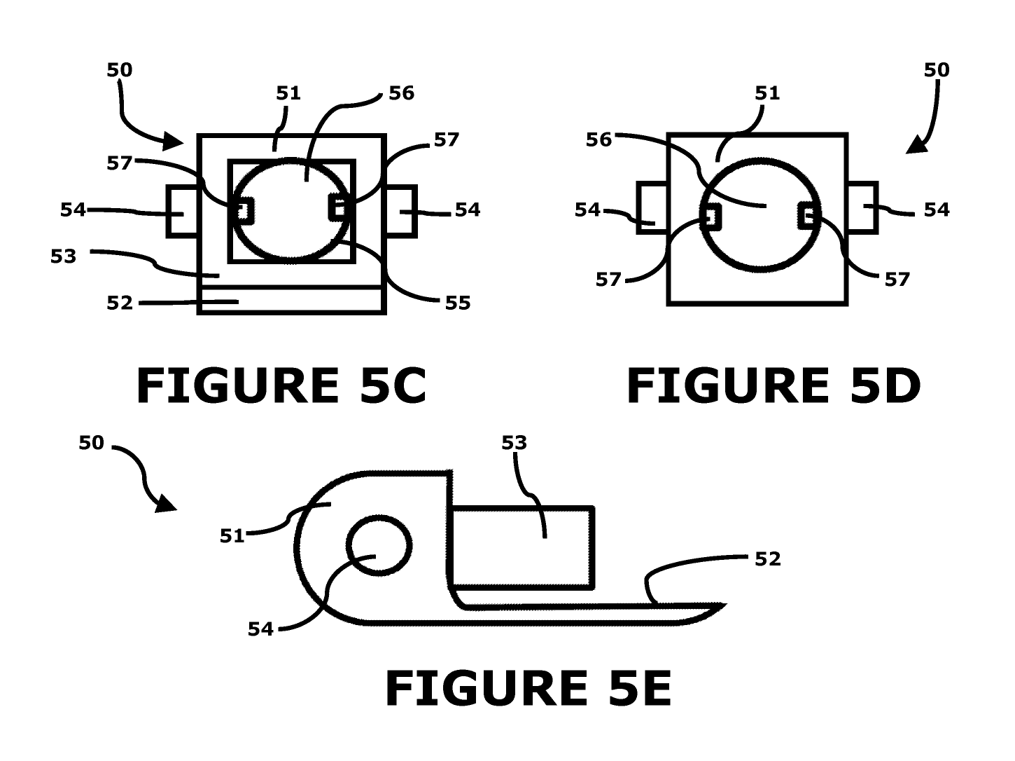

Referring to FIGS. 5A-5E, the cam 50 comprises a hub 51, a lid 52 extending tangentially from an upper region of the hub 51, and a sleeve 53 extending forwardly from the hub 51.

The hub 51 can be provided with rollers 54 or other means allowing the cam 50 to rotate relative to the cartridge 40 between the light-off position and the light-on position. The cam 50 can be adapted to rotate an amount necessary to achieve the desired slanted illumination (e.g., at least 40°, at least 50°, at least 60°, at least 70°, at least 80°, at least 90°, etc.).

A bulb-receiving channel 55 passes through the sleeve 53 and into the hub 51. A cap 56 plugs the rear end of the channel 55 and includes wire-accommodating openings 57.

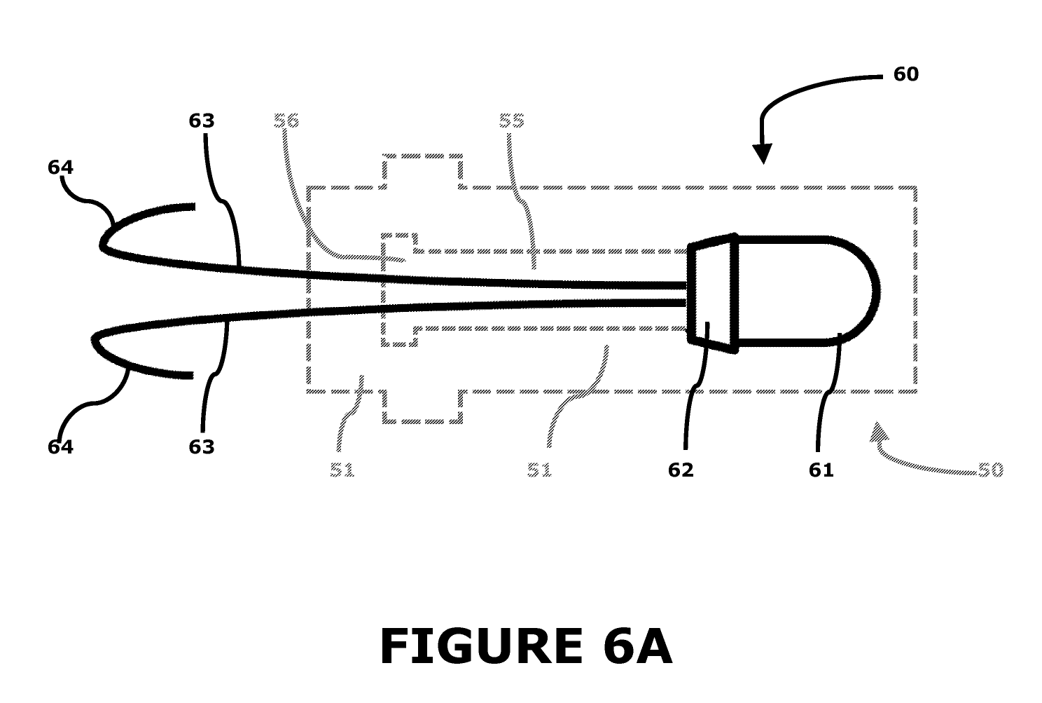

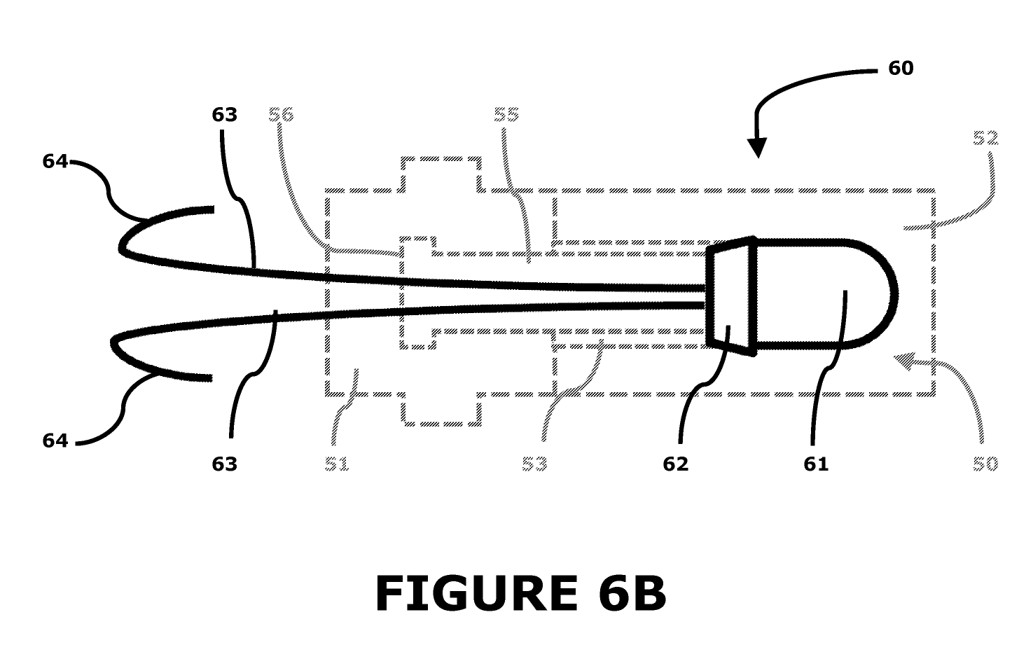

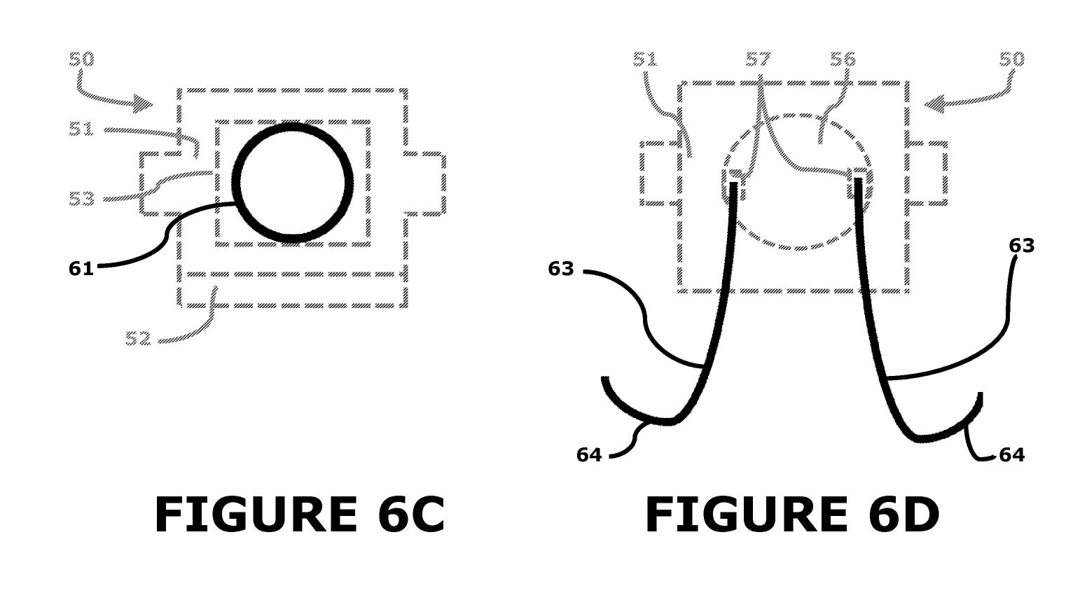

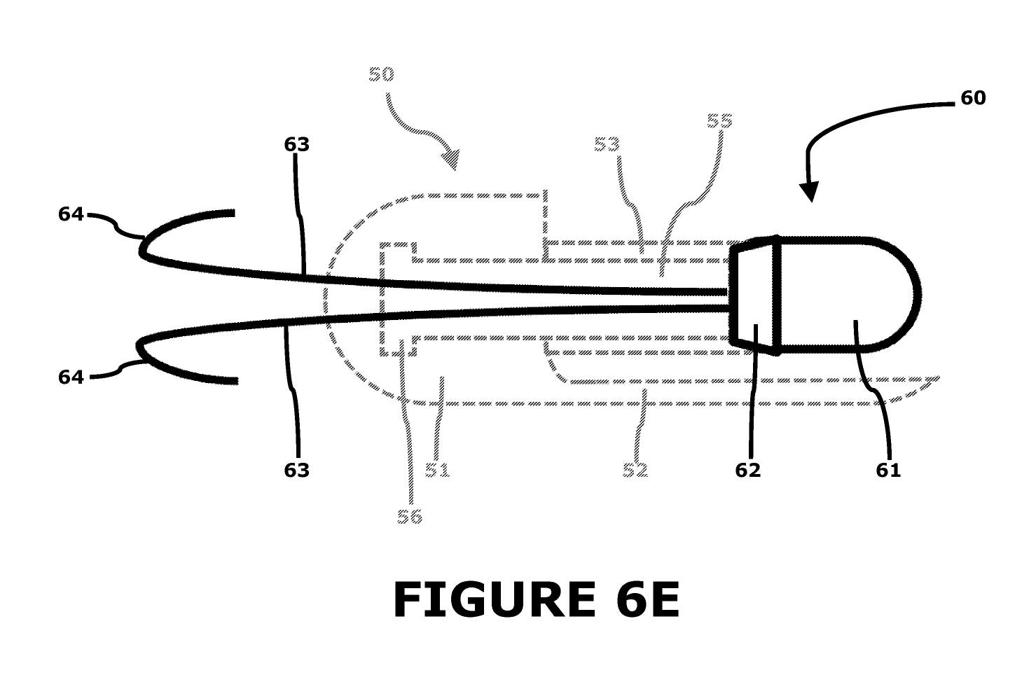

Referring to FIGS. 6A-6E, the illuminator 60 comprises bulb 61 and a collar 62 for engagement with the hub's sleeve 53. Wires 63, electrically connected to the bulb 61, pass through the hub's channel 55 and exit through the openings 57 in the rear cap 56. The ends of the wires 63 are provided with hooks or loops 64.

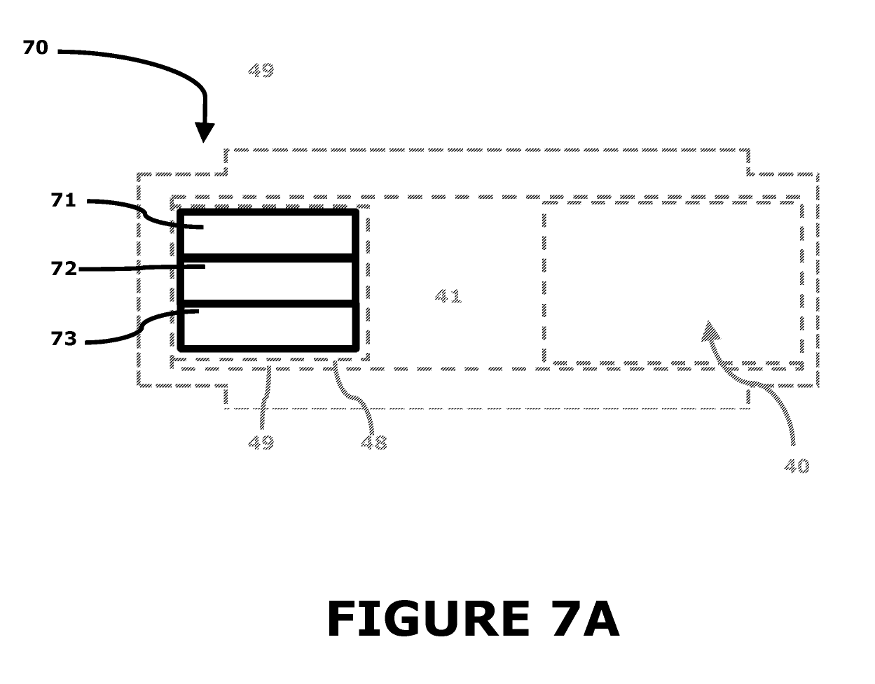

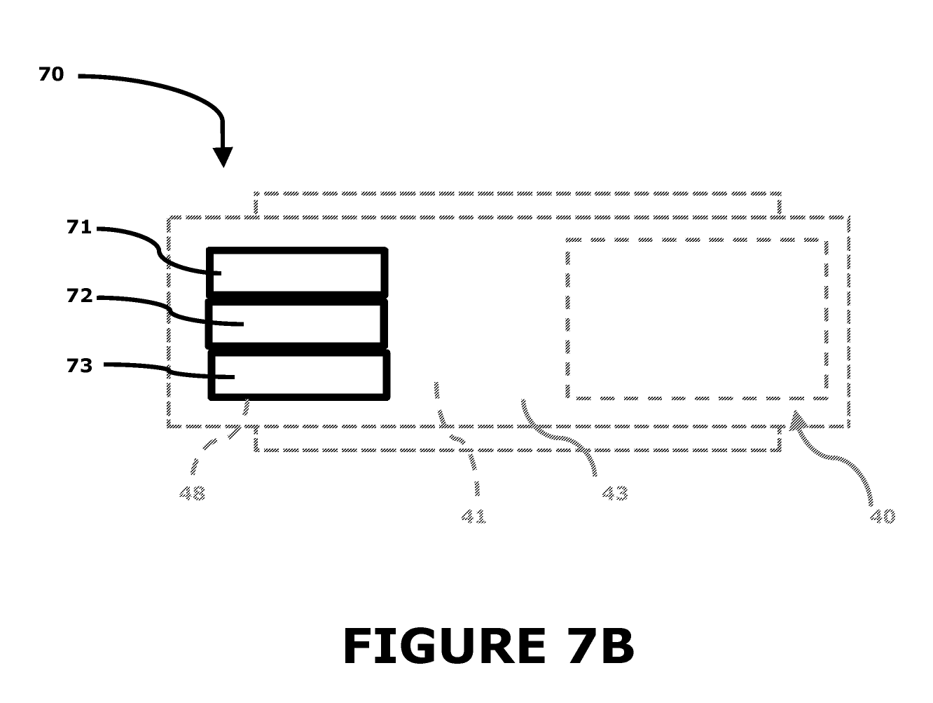

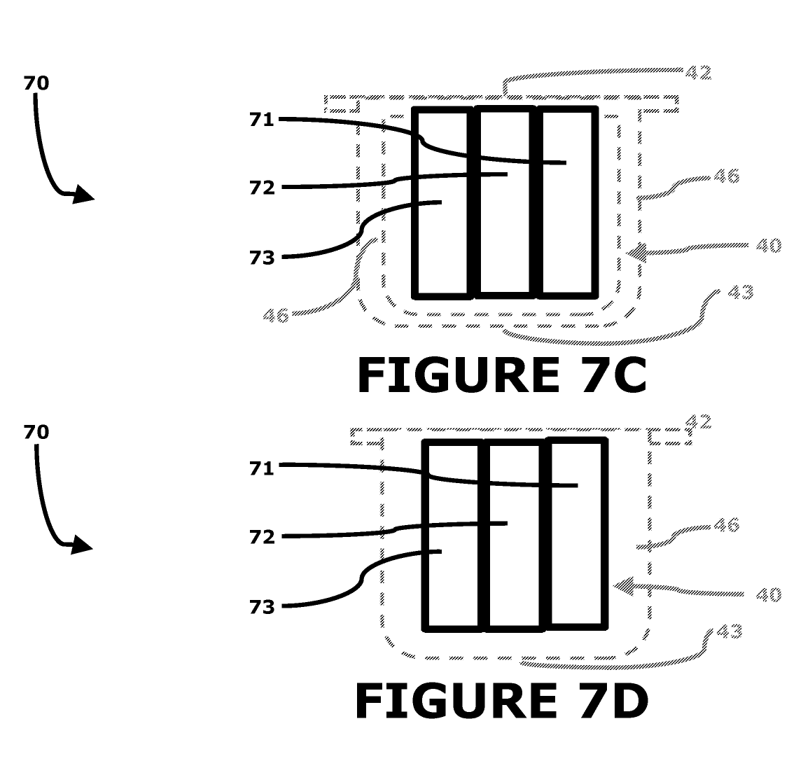

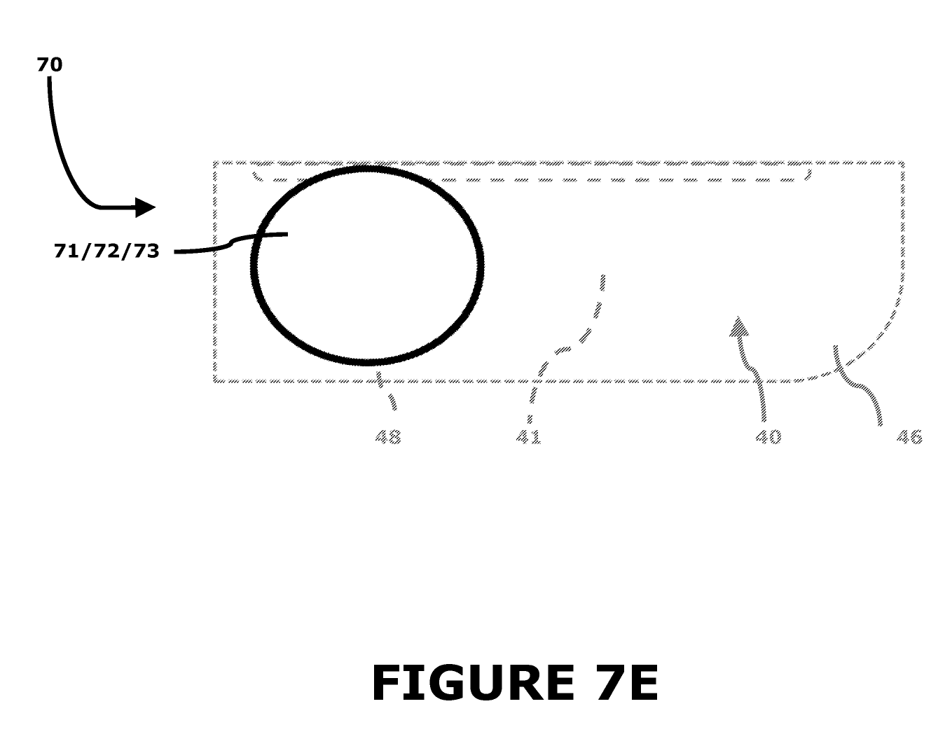

Referring to FIGS. 7A-7E, the power source 70 comprises three button cell batteries 71-73 stacked sideways in the battery holder 49. The batteries 71-73 can each 1.5V alkaline battery as they offer high energy capacity and longer-term storage. These batteries are commercially available from a variety of suppliers (e.g., Energizer BLR41, Energizer 389A, Eveready 189, Gold Peak GP189, Gold Peak GP89, Gold Peak GP89A, IEC LR54, JIS G10-A, JIS G10A, Mallory LR54, Maxell LR1130, NEDA 1168A, Rayovac 189-1, Vinnic L1131, Duracell D189, Duracell LR54, Maxell LR1130, Rayovac 189-1, Seiko LR1130, Sony 189, Varta V1OGA, National LR1130, Panasonic LR1130,

RayoVac 189-1, Sony LR1130, Toshiba LR1130, UCAR 189, CASIO CX189 etc.). That being said, other batteries and other non-battery power sources are feasible and foreseeable.

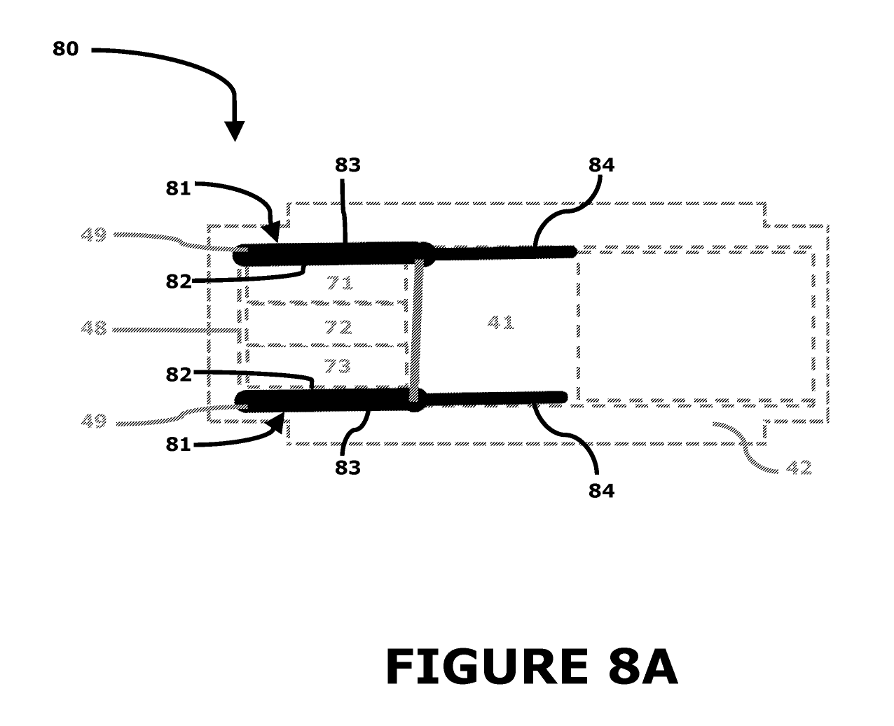

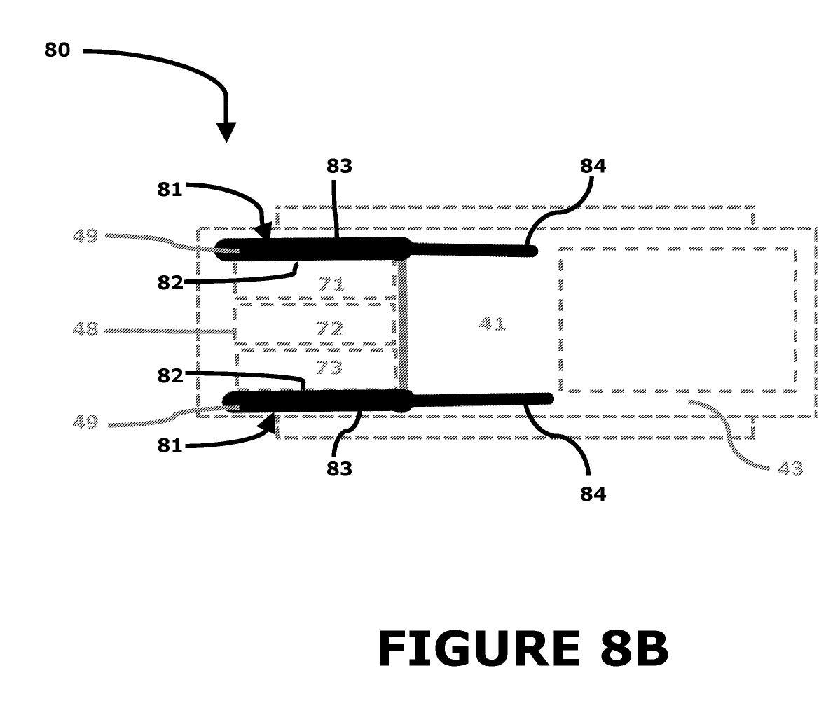

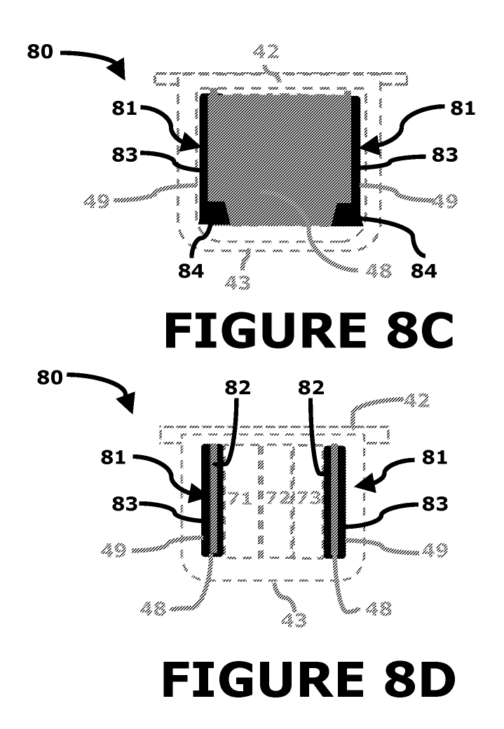

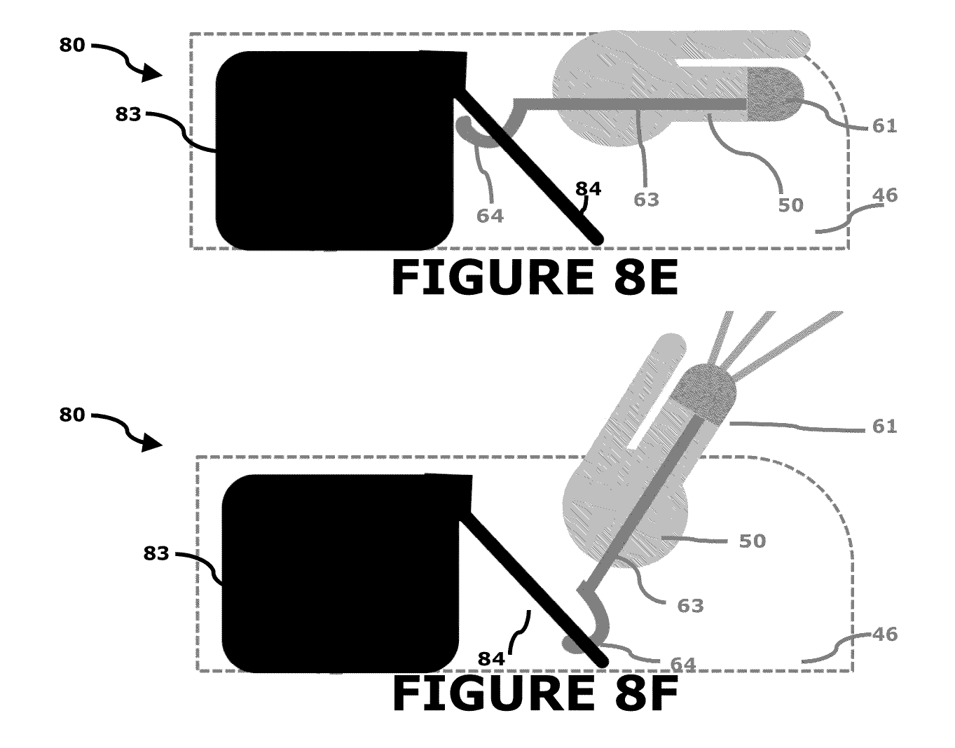

Referring to FIGS. 8A-8E, the electrical connection arrangement 80 can comprise terminal pads 81 on each lateral end of the stacked batteries 71-73. The pads 81 can each comprise a foil sheet folded over the sides of the battery holder 48 so that a section 82 is inside the holder 48 (and thus contacting the power source 70) and another section 83 is within the slot 49.

The pads 81 can also each have a ramp section 84 extending forward towards the cam 50. When the cam 50 is in the light-off position, the wire ends 64 do not contact the ramps 84 whereby no electrical power is provided to the bulb 61. When the cam 50 is in the light-on position, the wire ends 64 contact the ramps 84 whereby electrical power is provided to the bulb 61.

One may now appreciate that a light assembly 20 is provided which is adapted for attachable to a brim or any other substrate 10. The light direction can be tailored for different circumstances by placement of the base 30. All wires and switches are contained within the compartment 41 and non-noticeable on the substrate 10. Moreover, the light assembly 20 can be compactly constructed, can be economically manufactured, and can be easily operated, without compromising efficiency and effectiveness.

1. A light assembly, comprising:
a cartridge defining a compartment;
a cam movably connected to the cartridge for selective movement between a light-off position and a light-on position.
an illuminator mounted on the cam for movement therewith between the light-off position the light-on position, the illuminator being situated within the compartment when the cam is in the light-off position and the illuminator being situated to illuminate forward of the cartridge when the cam is in the light-on position;
a power source situated within the compartment;
an electrical connection arrangement which does not electrically connect the illuminator to the power source when the cam is in the light-off position and which does electrically connect the illuminator to the power source when the cam is in the light-on position;
whereby the illuminator is automatically turned on by selectively moving the cam to the light-on position and the illuminator is automatically turned off by selectively moving the cam to the light-off position;
wherein the assembly is less than 4 cm long, less than 3 cm wide, and less than 2 cm high when the cam is in its closed position.

2. A lighting assembly as set forth in claim 1, further comprising a base adapted for attachment to a substrate and wherein the cartridge is attached to the base.

3. A lighting assembly as set forth in claim 2, wherein the cartridge is removably attached to the base.

4. A lighting assembly as set forth in claim 2, wherein the cartridge is slidably attached to the base.

5. A lighting assembly as set forth in claim 2, wherein the base is less than 4 cm long and less thn 3 cm wide.

6. A lighting assembly as set forth in claim 2, wherein the base is formed in one piece.

7. A lighting assembly as set forth in claim 2, wherein the base is molded.

8. A lighting assembly as set forth in claim 1, wherein the cartridge is less than 4 cm long, less than 3 cm wide, and less than 2 cm high.

9. A lighting assembly as set forth in claim 8, wherein the cartridge is formed in one piece.

10. A lighting assembly as set forth in claim 9, wherein the cartridge is molded.

11. A lighting assembly as set forth in claim 1, wherein the cartridge comprises interior walls forming a battery holder.

12. A lighting assembly as set forth in claim 1, wherein the cam is at least 50% as wide as the cartridge.

13. A lighting assembly as set forth in claim 1, wherein the cam is formed in one piece.

14. A lighting assembly as set forth in claim 13, wherein the cam is molded.

15. A lighting assembly as set forth in claim 1, wherein the cam is pressfit into the cartridge.

16. A lighting assembly as set forth in claim 1, wherein the cam rotates relative to the cartridge to move between the light-off position and the light-on position.

17. A lighting assembly as set forth in claim 16, wherein the cam rotates at least 30° to move between the light-off position and the light-on position.

18. A lighting assembly as set forth in claim 17, wherein the cam rotates at least 40° to move between the light-off position and the light-on position.

19. A lighting assembly as set forth in claim 18, wherein the cam rotates at least 60° to move between the light-off position and the light-on position.

20. A lighting assembly as set forth in claim 19, wherein the cam rotates at least 90° to move between the light-off position and the light-on position.
